(19) United States
(12) Patent Application Publication
(10) Pub. No.: US 2008/0175449 A1
(43) Pub. Date: Jul. 24, 2008

(54) Fingerprint-based network authentication method and system thereof

(75) Inventors: Sung-Jen Fang, Hsin-Chu City (TW); Chap-Meng Bee, Jhunan Township (TW); Jer-Chuan Huang, Yijhu Township (TW)

Correspondence Address: TROXELL LAW OFFICE PLLC, SUITE 1404, 5205 LEESBURG PIKE, FALLS CHURCH, VA, 22041, US

(73) Assignee: Wison Technology Corp.

(21) Appl. No.: 11/655,290

(22) Filed: Jan. 19, 2007

(51) Int. Cl. G06K 9/00

(52) U.S. Cl. 382/124

(57) ABSTRACT

A fingerprint-based network authentication method and system thereof comprises a user end and an authentication end. The user end has a fingerprint capture device comprising a fingerprint capture unit, a fingerprint processing unit, and a transmission unit. The fingerprint capture unit captures a fingerprint image, which is received and packaged into a data packet by the fingerprint processing unit. The transmission unit transmits the data packet. The authentication end has an authentication device comprising a transmission unit, a fingerprint processing and control unit, a data storage unit, and an interface unit. The transmission unit receives the data packet. The fingerprint processing and control unit receives and compares the data packet. The data storage unit stores fingerprint data and related user data. The interface unit transforms a comparison result into a control signal and replies the authentication result so as to authenticate the user's identity and confirm the limits of authority.

### FIELD OF THE INVENTION

The present invention relates to a fingerprint-based network authentication method and system thereof, and more particularly to a fingerprint-based network authentication method and system thereof, which are applied to an access point, an authentication server, or the like, which are mounted on an authentication end of a local area network, for recognizing identity.

### BACKGROUND OF THE INVENTION

With the development of technology in modern society, the general public promotes the work efficiency by using computers and explores the virtual world by using networks. The browsers are widely applied to the daily life after their disclosure to the general public. With the extensive utilization of network, the general public is dependent on the networks progressively.

After several years of development, the basal construction of local area network is changed from the previous 10 Mbps toward the existing 100 Mbps. There are three kinds of commercial products having different transmission speeds of IEEE 802.11b 11 Mbps, 802.11a 54 Mbps, and 802.11g 54 Mbps. However, the network has the potential security risks. Both the wired and the wireless local area networks, which offer the identical functions, may be hacked by hackers. The wireless network is accessible as long as the workstation is located within the reachable range of the signal of the access point. However, the wired network is accessible only in a location that provides the network socket. As a result, the wireless network suffers from the attack easily, causing security leaks. In addition, the application of network may be affected significantly.

The IEEE 802 family, which is defined by the Institute of Electrical and Electronic Engineer (IEEE), is principally adopted as wireless local area network standards. For the purpose of providing higher security for wireless network communication, a WEP (Wired Equivalent Privacy) protocol is further defined among the standards of IEEE 802 family. This WEP protocol uses the RC4 stream cipher with key length up to merely 40 bits so its security is always doubtful. In addition, the key of the WEP protocol is sharable by manual input. The method of sharing the key is not defined so it is not easy to update the key. Therefore, the WEP protocol may be attacked by brute-force search or known-plaintext attack.

A Wi-Fi protected access (WPA) standard that has enhanced security is disclosed by Wi-Fi association and IEEE together for replacing the existing poor security WEP standard. The WPA standard utilizes the temporal key integrity protocol (TKIP), which uses the RC4 encryption algorithms with key length up to 128 bits, for enhancing the security of encrypted data. In addition, it also utilizes the message authentication code (MAC) for authentication so as to make sure the completeness of information and to resist message replaying attack. In addition, the WPA also provides the function of authenticating the user's login information. The WPA has built-in IEEE 802.1x standard and extensible authentication protocol (EAP). Accordingly, the user is granted to access the network or the accounting is started only when the user passes the authentication of central server.

Although the above-mentioned standards are able to improve the authentication mechanisms of network, some authentication mechanisms may be hacked, causing the loss of data and enormous damage to the enterprises and the individuals.

In view of this, the present invention intends to provide an authentication mechanism with fingerprint minutia so as to control the network system effectively. In addition, the present invention also provides the network system that has the fingerprint minutia stored therein with the function of authenticating the fingerprint minutia.

### SUMMARY OF THE INVENTION

It is a principal object of the present invention to provide a network system with an authentication device for authenticating the fingerprint minutia so as to enhance the security of network.

It is a secondary object of the present invention to provide a network system that has the fingerprint minutia stored therein with the function of recognizing the identity for increasing the security level.

It is a further object of the present invention to provide a network system that has the fingerprint minutia stored therein with the function of recognizing the identity for increasing the accounting accuracy.

In order to achieve the above-mentioned object, a fingerprint-based network authentication method and system thereof is composed of a user end and an authentication end for authentication and authorization. The user end has a fingerprint capture device comprising a fingerprint capture unit, a fingerprint processing unit, and a transmission unit. The fingerprint capture unit captures the user's fingerprint image. The fingerprint processing unit receives the fingerprint image captured by the fingerprint capture unit and packages it into a data packet of self-described protocol with variable length (SPVL). The transmission unit transmits the data packet formed by the fingerprint processing unit. The authentication end has an authentication device comprising a transmission unit, a fingerprint processing and control unit, a data storage unit, and an interface unit. The transmission unit receives the data packet transmitted from the transmission unit of the fingerprint capture device. The fingerprint processing and control unit receives the data packet transmitted from the transmission unit and compares the data packet with the fingerprint minutia established in the data storage unit. The data storage unit is connected with the fingerprint processing and control unit for storing fingerprint minutia data and related user data. The interface unit transforms the comparison result of the fingerprint processing and control unit into a control signal and replies the authentication result. Accordingly, the user can be authenticated by using the fingerprint minutia so as to authenticate the user's identity and confirm the limits of authority, thereby granting the user the right of use.

The aforementioned objects and advantages of the present invention will be readily clarified in the description of the preferred embodiments and the enclosed drawings of the present invention.

### BRIEF DESCRIPTION OF THE DRAWINGS

FIG. 1 is a schematic block diagram showing the main frame of the fingerprint-based network authentication system of the present invention.

FIG. 2 is a schematic process diagram showing the fingerprint-based network authentication method of the present invention.

FIG. 3 is a schematic diagram showing a first application status of the fingerprint-based network authentication system of the present invention.

FIG. 4 is a schematic diagram showing a second application status of the fingerprint-based network authentication system of the present invention.

FIG. 5 is a schematic diagram showing the packet format defined by SPVL protocol of the present invention.

### DETAILED DESCRIPTION OF THE PREFERRED EMBODIMENT

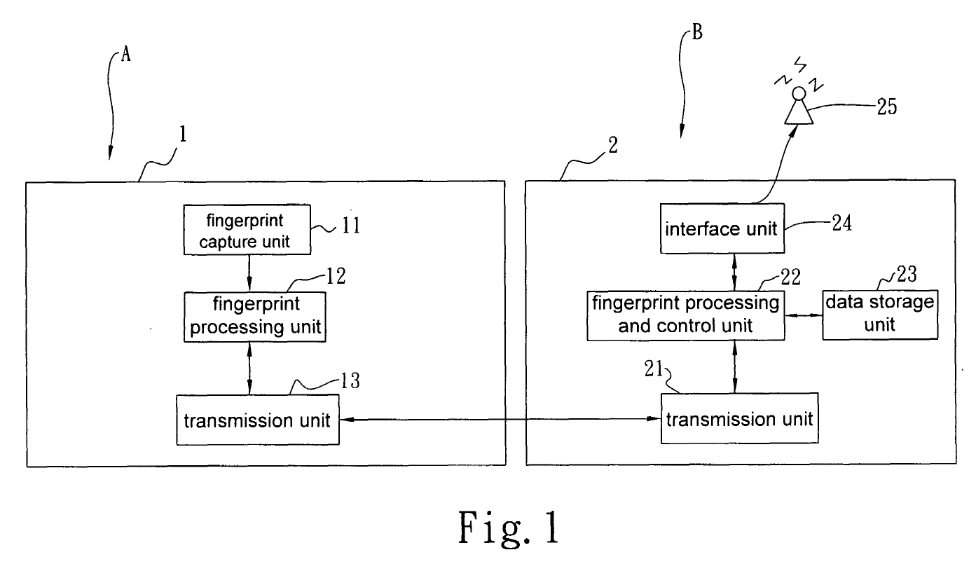

FIG. 1 shows a schematic block diagram of the main frame of the fingerprint-based network authentication system of the present invention. As shown in FIG. 1, the fingerprint-based network authentication system comprises a user end A and an authentication end B for authentication and authorization. The user end A has a fingerprint capture device 1 comprising a fingerprint capture unit 11, a fingerprint processing unit 12, and a transmission unit 13. The fingerprint capture unit 11 captures the user's fingerprint image. The fingerprint processing unit 12 receives the fingerprint image captured by the fingerprint capture unit 11 and packages it into a data packet of self-described protocol with variable length (SPVL). The transmission unit 13 transmits the data packet formed by the fingerprint processing unit 12. The authentication end B has an authentication device 2 comprising a transmission unit 21, a fingerprint processing and control unit 22, a data storage unit 23, and an interface unit 24. The transmission unit 21 receives the data packet transmitted from the transmission unit 13 of the fingerprint capture device 1. The fingerprint processing and control unit 22 receives the data packet transmitted from the transmission unit 21 and compares the data packet with the fingerprint minutia established in the data storage unit 23. The data storage unit 23 is connected with the fingerprint processing and control unit 22 for storing fingerprint minutia data and related user data. The interface unit 24 transforms the comparison result of the fingerprint processing and control unit 22 into a control signal 25 and replies the authentication result. Accordingly, the user can be authenticated by using the fingerprint minutia so as to authenticate the user's identity and confirm the limits of authority, thereby granting the user the right of use.

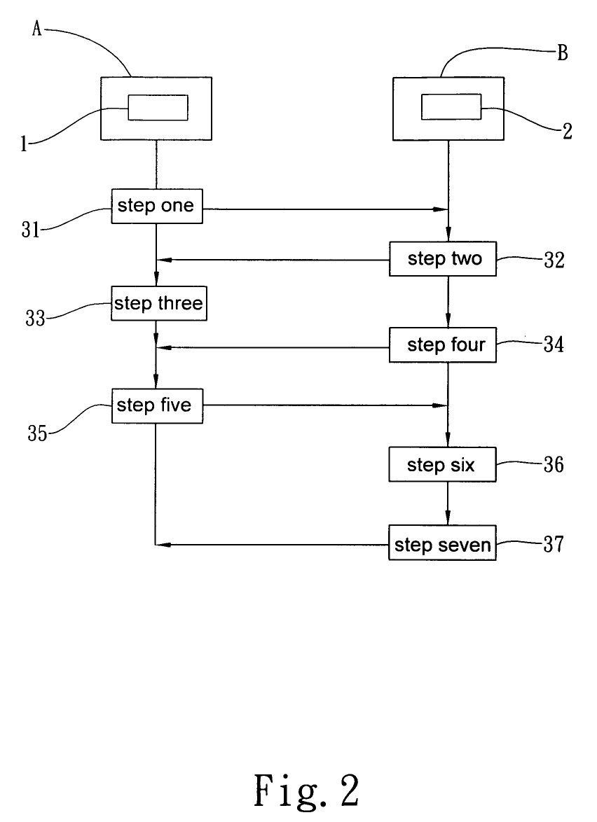

Referring to FIG. 2, a schematic process diagram of the fingerprint-based network authentication method of the present invention is shown. The user end A and the authentication end B share a secret key, wherein the authentication end B sends out a effective time-dependent random number to the user end A. The user end A links up the user's fingerprint image, the secret key, and the effective time-dependent random number so as to form a packet and send back this packet to the authentication end B. Next, the authentication end B performs the operation so as to compare the fingerprint image, the secret key, and the effective time-dependent random number so as to authenticate the user's identity and confirm the time-based effectiveness of the packet.

The fingerprint-based network authentication method comprises the following steps of:

step one 31: starting an authentication protocol by the user end;

step two 32: asking the user end to input the fingerprint image by the authentication end;

step three 33: capturing the fingerprint image by the fingerprint capture device of the user end;

step four 34: sending a effective time-dependent random number to the user end by the authentication end;

step five 35: performing the operation by the user end so as to link up the fingerprint image, the secret key, and the effective time-dependent random number for forming a packet and sending back this packet to the authentication end;

step six 36: performing the operation by the authentication end for reading the data of fingerprint minutia from the authentication device so as to compare the fingerprint minutia; and

step seven 37: granting the user to access the network resources if the user passes the authentication and replying the authentication result.

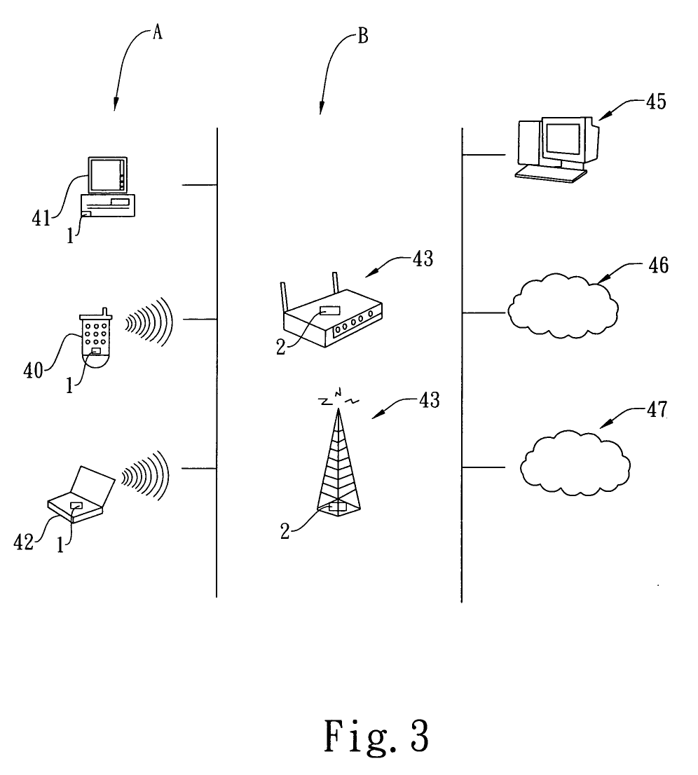

Referring to FIG. 3, a schematic diagram of a first application status of the fingerprint-based network authentication system is shown. The fingerprint capture device 1 of the user end A is coupled with a personal mobile communication device 40 such as a mobile phone, a PDA, and so on. The fingerprint capture device 1 is mounted on the inside of the personal mobile communication device 40. Alternatively, the fingerprint capture device 1 is coupled with a personal computer 41, a notebook computer 42, or a compact computer, and so forth. In addition, the fingerprint capture device 1 can be mounted on the inside or the outside of the personal computer 41, the notebook computer 42, or the compact computer. In addition, the user's fingerprint image is captured by the fingerprint capture device 1, and the fingerprint image is transmitted to the authentication device 2 of the authentication end B in the format of packet by a wireless or a wired two-way communication method. The authentication device 2 of the authentication end B is coupled with an access point 43, and mounted on the inside of the access point 43. In addition, the authentication device 2 of the authentication end B performs the operation on the received packet and compares the fingerprint minutia for authenticating the user. If the authentication is passed, the user is granted to access the network resources including internet 45, network application 46, network service 47, and so on.

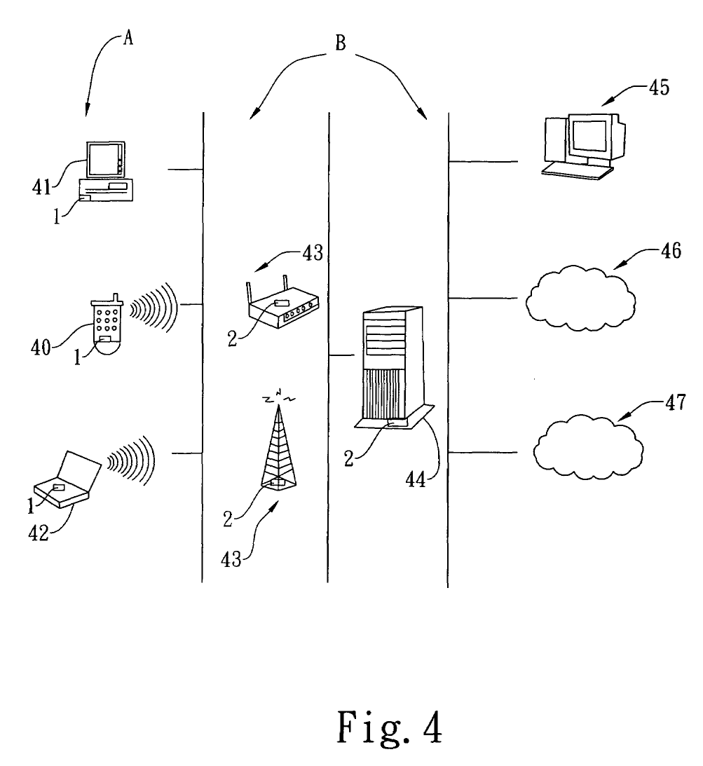

Referring to FIG. 4, a schematic diagram of a second application status of the fingerprint-based network authentication system is shown. The fingerprint capture device 1 of the user end A is coupled with a personal mobile communication device 40 such as a mobile phone, a PDA, and so on. The fingerprint capture device 1 is mounted on the inside of the personal mobile communication device 40. Alternatively, the fingerprint capture device 1 is coupled with a personal computer 41, a notebook computer 42, or a compact computer, and so forth. In addition, the fingerprint capture device 1 can be mounted on the inside or the outside of the personal computer 41, the notebook computer 42, or the compact computer. In addition, the user's fingerprint image is captured by the fingerprint capture device 1, and the fingerprint image is transmitted to the authentication device 2 of the authentication end B in the format of packet. The authentication device 2 of the authentication end B is coupled with an access point 43 and an authentication server 44, and mounted on the inside of the access point 43, wherein the fingerprint processing and control unit 22 and the data storage unit 23 of the authentication device 2 of the authentication end B are mounted in the authentication server 44. In addition, the transmission unit 21 and the interface unit 24 are mounted in the access point 43. The fingerprint image of the user end A is transmitted to the access point 43 of the authentication end B in the format of packet by a wireless or a wired two-way communication method, and then transmitted to the authentication server 44. Next, the fingerprint processing and control unit 22 mounted inside the authentication server 44 performs the operation on the received packet and performs the minutia comparison with the fingerprint minutia stored in the data storage unit 23 for authenticating the user. If the authentication is passed, the user is granted to access the network resources so as to authenticate the user's identity and confirm the limits of authority. After comparison, the comparison result is sent back to the interface unit 24 inside the access point 43 and transformed into a control signal 25 for access to the network resources including internet 45, network application 46, network service 47, and so on.

In addition, the access of mobile user to the wireless local area network can be managed by coupling with the enterprise or the internet service provider via the IEEE802.1x standard, the AAA (authentication authorization accounting) server, and the user's fingerprint database. Before authorizing the user to access the wireless local area network, which is controlled by the IEEE802.1x standard, the user must first provide fingerprint, digital public-key certificate, or other information for authenticating the user for the AAA server via the EAPOL protocol, the wireless access device or the wireless broadband router. Only the legal user who passes the server's authentication can utilize the wireless local area network so as to access the service provided by the system. The AAA server also records the user's login and logout time so as to account the fees and monitor the usage status of network.

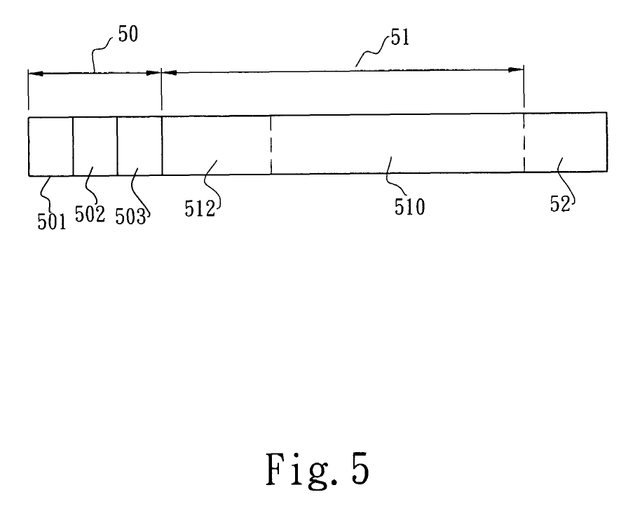

Another characteristic of the present invention is to achieve the flexible, multi-functional application by the use of the self-described protocol with variable length (SPVL). This communication protocol is able to self-describe various types of data and has variable length. Referring to FIG. 5, the packet format, which is defined by the SPVL protocol, is comprised of a header 50, a data body 51 and a checksum 52. The header 50 comprises: an opcode 501 for representing a remote control operation code; a device ID 502 for representing a hand-held remote control device's identity code; and a data length 503 for representing the length of the data body 51 inside the data packet.

The data body 51 comprises: a data content 510, which is a payload for values of various data types; and a data descriptor 512, which is a data description symbol for describing the data type and the length of the data content 510.

The checksum 52 is an integrity check value of the entire packet.

The data descriptor 512 has the function of self-description with variable length so that it can be changed according to the data characteristic so as to make the packet become small and accelerate the data transmission speed. Besides, there is no need to transmit the packet in sequence such that the flexible, multi-functional application can be achieved and that the information for recording the packet sequence can be thus omitted.

In accordance with the foregoing description, the present invention has the following advantages:

1. The device for recognizing fingerprint is added to the authentication end of the network authentication system for authenticating the user by using fingerprint minutia so as to enhance the security of network.

2. The network authentication system that has the fingerprint minutia stored therein is capable of recognizing the identity for increasing the security level.

3. The network authentication system that has the fingerprint minutia stored therein is capable of recognizing the identity for increasing the accounting accuracy.

In summary, the present invention discloses a unique fingerprint-based network authentication system and authentication method thereof for authenticating the user by using the fingerprint minutia such that the user's identity and the limits of authority can be thus confirmed so as to grant the user the right of use. Therefore, the network authentication system that has the fingerprint minutia stored therein is provided with improved security and increased security level. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A fingerprint-based network authentication system comprising:
a user end having a fingerprint capture device comprising a fingerprint capture unit, a fingerprint processing unit, and a transmission unit, wherein said fingerprint capture unit captures a user's fingerprint image, said fingerprint processing unit receives said fingerprint image captured by said fingerprint capture unit and packages said fingerprint image into a data packet defined by a self-described protocol with variable length (SPVL), and said transmission unit transmits said data packet formed by said fingerprint processing unit; and
an authentication end for authentication and authorization, said authentication end having an authentication device comprising a transmission unit, a fingerprint processing and control unit, a data storage unit, and an interface unit, wherein said transmission unit receives said data packet transmitted from said transmission unit of said fingerprint capture device, and said fingerprint processing and control unit receives said data packet transmitted from said transmission unit and compares said data packet with a fingerprint minutia established in said data storage unit, wherein said data storage unit is connected with said fingerprint processing and control unit for storing fingerprint minutia data and related user data, and said interface unit transforms a comparison result of said fingerprint processing and control unit into a control signal and replies the authentication result so as to authenticate said user's identity and confirm the limits of authority by using said fingerprint minutia, thereby granting said user the right of use.

2. A fingerprint-based network authentication system of claim 1, wherein said fingerprint capture device of said user end is mounted in a personal mobile communication device, a personal computer (PC), a thin client computer, or a notebook computer (NB).

3. A fingerprint-based network authentication system of claim 1, wherein said fingerprint capture device of said user end is mounted externally on a personal mobile communication device, a personal computer (PC), a thin client computer, or a notebook computer (NB).

4. A fingerprint-based network authentication system of claim 1, wherein said authentication device of said authentication end is mounted in an access point.

5. A fingerprint-based network authentication system of claim 1, wherein said authentication device of said authentication end is mounted in an authentication server.

6. A fingerprint-based network authentication system of claim 1, wherein said fingerprint processing and control unit and said data storage unit of said authentication device of said authentication end are mounted in an authentication server, and said transmission unit and said interface unit are mounted in an access point.

7. A fingerprint-based network authentication system of claim 1, wherein said transmission unit of said fingerprint capture device of said user end and said transmission unit of said authentication device of said authentication end can perform wireless two-way communication.

8. A fingerprint-based network authentication system of claim 1, wherein said transmission unit of said fingerprint capture device of said user end and said transmission unit of said authentication device of said authentication end can perform wired two-way communication.

9. A fingerprint-based network authentication system of claim 1, wherein said fingerprint image captured by said fingerprint capture device of said user end is transformed into said fingerprint minutia.

10. An fingerprint-based network authentication system of claim 1, wherein a packet format of said data packet, which is defined by said self-described protocol with variable length (SPVL), is comprised of a header, a data body and a checksum, wherein said header comprises:
an opcode for representing a remote control operation code; a device ID for representing a hand-held remote control device's identity code; and a data length for representing a length of said data body inside said data packet, wherein said data body comprises:
a data content, which is a payload for values of various data types; and
a data descriptor, which is a data description symbol for describing a data type and a length of said data content and has the function of self-description with variable length, such that the information of said fingerprint minutia can be recombined by the use of a fingerprint minutia matching algorithm without the need to transmit said data packet in sequence, whereby the flexible, multi-functional application can be achieved.

11. A fingerprint-based network authentication method in which a user end and an authentication end share an secret key, said authentication end sends out a effective time-dependent random number to said user end, said user end links up a user's fingerprint image, said secret key, and said effective time-dependent random number for forming a packet and sending back said packet to said authentication end, and said authentication end performs an operation so as to compare said fingerprint image, said secret key, and said effective time-dependent random number for authenticating said user, said fingerprint-based network authentication method comprising:
step one: starting an authentication protocol by said user end;
step two: asking said user end to input said fingerprint image by said authentication end;
step three: capturing said fingerprint image by a fingerprint capture device of said user end;
step four: sending said effective time-dependent random number to said user end by said authentication end;
step five: performing said operation by said user end so as to link up said fingerprint image, said secret key, and said effective time-dependent random number for forming said packet and sending back said packet to said authentication end;
step six: performing said operation by said authentication end for reading data of fingerprint minutia from an authentication device so as to compare a fingerprint minutia; and
step seven: granting said user to access network resources if said user passes the authentication and replying the authentication result.

12. A fingerprint-based network authentication method of claim 11, wherein said fingerprint capture device of said user end is mounted in a personal mobile communication device, a personal computer (PC), a thin client computer, or a notebook computer (NB).

13. A fingerprint-based network authentication method of claim 11, wherein said fingerprint capture device of said user end is mounted externally on a personal mobile communication device, a personal computer (PC), a thin client computer, or a notebook computer (NB).

14. A fingerprint-based network authentication method of claim 11, wherein said authentication device of said authentication end is mounted in an access point.

15. A fingerprint-based network authentication method of claim 11, wherein said authentication device of said authentication end is mounted in an authentication server.

16. A fingerprint-based network authentication method of claim 11, wherein a fingerprint processing and control unit and a data storage unit of said authentication device of said authentication end are mounted in an authentication server, and a transmission unit and an interface unit are mounted in an access point.

17. A fingerprint-based network authentication method of claim 11, wherein a transmission unit of said fingerprint capture device of said user end and a transmission unit of said authentication device of said authentication end can perform wireless two-way communication.

18. A fingerprint-based network authentication method of claim 11, wherein a transmission unit of said fingerprint capture device of said user end and a transmission unit of said authentication device of said authentication end can perform wired two-way communication.

19. A fingerprint-based network authentication method of claim 11, wherein said fingerprint image captured by said fingerprint capture device of said user end is transformed into said fingerprint minutia.

20. An fingerprint-based network authentication method of claim 11, wherein a packet format of said packet, which is defined by a self-described protocol with variable length (SPVL), is comprised of a header, a data body, and a checksum, wherein said header comprises:
an opcode for representing a remote control operation code; a device ID for representing a hand-held remote control device's identity code; and a data length for representing a length of said data body inside said packet, wherein said data body comprises:
a data content, which is a payload for values of various data types; and
a data descriptor, which is a data description symbol for describing a data type and a length of said data content and has the function of self-description with variable length, such that the information of said fingerprint minutia can be recombined by the use of a fingerprint minutia matching algorithm without the need to transmit said packet in sequence, whereby the flexible, multi-functional application can be achieved.
